(19) United States
(12) Patent Application Publication
(10) Pub. No.: US 2025/0180745 A1
(43) Pub. Date: Jun. 5, 2025

(54) LIDAR ODOMETRY USING PIECEWISE LINEAR CONTINUOUS-TIME TRAJECTORY

(71) Applicant: ZHEJIANG UNIVERSITY, Hangzhou (CN)

(72) Inventors: Jianke ZHU, Hangzhou (CN); Xin ZHENG, Hangzhou (CN)

(73) Assignee: ZHEJIANG UNIVERSITY, Hangzhou (CN)

(21) Appl. No.: 18/916,786

(22) Filed: Oct. 16, 2024

Related U.S. Application Data
(63) Continuation-in-part of application No. PCT/CN2024/081903, filed on Mar. 15, 2024.

(30) Foreign Application Priority Data
Nov. 30, 2023 (CN) 202311627956.X

(51) Int. Cl. G01S 17/89; G06T 7/246

(52) U.S. Cl. CPC G01S 17/89; G06T 7/246; G06T 2207/10028; G06T 2207/30241

(57) ABSTRACT

The provided is a LiDAR odometry using a piecewise linear continuous-time trajectory. The LiDAR odometry includes the following steps: dividing an initial LiDAR point cloud time sequence through time windows to obtain LiDAR point cloud subsequences in the multiple time windows, and constructing an initial local point cloud map; and optimizing, based on the initial local point cloud map, a LiDAR pose for the LiDAR point cloud subsequence in each time window to obtain an overall continuous-time trajectory and a final local point cloud map. The provided achieves high-precision motion estimation of the LiDAR, with high robustness and real-time performance, and is suitable for fields such as robot navigation, simultaneous localization and mapping, and autonomous driving. The provided gives a simple and efficient solution that effectively utilizes the characteristics of the LiDAR as a streaming sensor.

### CROSS-REFERENCE TO THE RELATED APPLICATIONS

This application is a continuation-in-part application of International Application No. PCT/CN2024/081903, filed on Mar. 15, 2024, which is based upon and claims priority to Chinese Patent Application No. 202311627956.X, filed on Nov. 30, 2023, the entire contents of which are incorporated herein by reference.

### TECHNICAL FIELD

The present disclosure relates to simultaneous localization and mapping related technology in the field of robotics, and in particular to an odometry that relies solely on a LiDAR input and uses a piecewise linear continuous-time trajectory.

### BACKGROUND

LiDAR odometry is a crucial component in many robotics applications. Due to the excellent distance sensing capability of LiDAR, LiDAR odometry plays a crucial role in robot navigation and path planning in global position system (GPS) restricted environments.

After years of exploration and development, methods relying solely on a single LiDAR sensor lack accuracy and robustness. The method of multi-sensor fusion is widely regarded as the best solution in practical applications. The LiDAR-inertial odometry (LIO), which tightly couples information from the inertial measurement unit (IMU), has an especially wide range of applications in practice. Compared with existing methods that rely solely on LiDAR information, LIO provides advantages in two aspects. That is, the high-frequency IMU states contribute to accurate motion compensation, and the IMU enhances the robustness of the system by directly applying a kinematic constraint. However, stable LIO largely relies on accurate calibration of IMU parameters, and IMU data is highly sensitive to temperature changes and mechanical impacts. In addition, even the most advanced LIO systems currently available are hard to handle in situations where the dynamic state exceeds the IMU measurement range.

In fact, LiDAR is a streaming sensor accompanied with continuous motion to capture scene structures. Previous research on LiDAR odometry represented the motion trajectory as a series of discrete-time poses, breaking the inherent connection between the acquired geometric information and sensor motion. Therefore, the accuracy of current odometry that relies solely on the LiDAR input is much lower than that of multi-sensor fusion odometry.

### SUMMARY

In order to solve the problems mentioned in the background section, the present disclosure provides a novel continuous-time trajectory parameterization method for motion estimation of a LiDAR odometry. The present disclosure is applicable to various types of LiDARs, including multi-scan and non-repetitive scanning LiDARs, as well as different configurations of a single or multiple LiDAR systems.

The present disclosure adopts the following technical solutions.
I. A LiDAR odometry using a piecewise linear continuous-time trajectory, including:
S1: dividing an initial LiDAR point cloud time sequence through time windows to obtain LiDAR point cloud subsequences in the multiple time windows, and constructing an initial local point cloud map;
S2: linearly parameterizing the LiDAR point cloud subsequence in each time window to obtain an initial continuous-time trajectory;
S3: calculating, based on a current continuous-time trajectory and a current local point cloud map, a point-to-plane error corresponding to each point in a current time window, thereby forming a point-to-plane error constraint; and establishing a trajectory smoothness constraint;
S4: minimizing, based on the point-to-plane error constraint and the trajectory smoothness constraint, an objective function by a Gauss-Newton method; and estimating and updating the continuous-time trajectory in the current time window;
S5: repeating the steps S3 and S4: iteratively optimizing a pose in the current time window based on the updated continuous-time trajectory until the objective function is less than a preset threshold, to obtain an optimal continuous-time trajectory in the current time window and a corresponding LiDAR point cloud in a world coordinate system; and adding the LiDAR point cloud in the world coordinate system in the current time window to the current local point cloud map; and
S6: repeating the steps S2 to S5: sequentially optimizing a LiDAR pose for the LiDAR point cloud subsequence in each time window to obtain an overall continuous-time trajectory.

In the step S3, the calculating a point-to-plane error corresponding to each point in a current time window specifically includes:
acquiring, based on the current continuous-time trajectory, a position Tᵢ of a LiDAR in the world coordinate system at a corresponding time of a current point pᵢ; finding multiple near points to the current point in the current local point cloud map, and defining the nearest point in the multiple near points as qᵢ; calculating, by a principal component analysis (PCA) method, a normal vector nᵢ corresponding to the multiple points; and calculating the point-to-plane error corresponding to each point as follows:

$${e}_{i} = {n}_{i}^{T} ( {T}_{i} {p}_{i} - {q}_{i} )$$

where, eᵢ denotes the point-to-plane error corresponding to the current point pᵢ, and T denotes a transpose.

In the step S3, the trajectory smoothness constraint is expressed as follows:

$${e}_{{υ}_{k}} = {T}_{k} ⊖ {T}_{k - 1} - {{T}^{⋁}}_{k - 1} ⊖ {{T}^{⋁}}_{k - 2} .$$

where, eᵥ_{ₖ} denotes the trajectory smoothness constraint in a time window k; Tₖ⊖Tₖ₋₁ denotes a generalized velocity in the time window k; Ťₖ₋₁⊖Ťₖ₋₂ denotes a pseudo velocity measurement in the time window k; Tₖ₋₁ and Tₖ denote a starting pose and an ending pose in the current window k, respectively; and Ťₖ₋₂ and Ť^{k-1} denote a starting pose and an ending pose optimized in a previous time window k−1, respectively.

The objective function is expressed as follows:

$$E = \sum {e}_{i}^{T} {e}_{i} + \sum {e}_{{v}_{k}}^{T} {e}_{{v}_{k}}$$

where, E denotes a total trajectory error; eᵢ denotes a point-to-plane error corresponding to a current point pᵢ in the current time window; eᵥ_{ₖ} denotes the trajectory smoothness constraint in the current time window k; and T denotes a transpose.
II. A computer device, including:
a memory and a processor, where the memory is configured to store a computer program; and the computer program is executed by the processor to implement the steps of the method.
III. A computer-readable storage medium, configured to:
store a computer program, where the computer program is executed by a processor to implement the steps of the method.

The present disclosure has following beneficial effects:

The present disclosure proposes a motion representation method for a piecewise linear continuous-time trajectory. The motion within the entire time interval can be divided through multiple time intervals based on the motion situation, and the motion within each time interval can be represented by simple linear interpolation. This piecewise trajectory representation method solves the problem of linear interpolation being unable to represent complex motion, providing a concise and efficient mathematical representation for subsequent odometry estimation.

In the point cloud registration part of LiDAR odometry, the present disclosure additionally considers the timestamp information of each point, thereby utilizing the continuous-time trajectory representation method proposed above, eliminating the step of additional point cloud distortion elimination and reducing dependence on other sensors.

In the optimization part of odometry, the present disclosure introduces the kinematic constraint based on the smoothness of the continuous trajectory, and can achieve stable registration when the system dynamics state exceeds the general IMU measurement range.

The present disclosure adopts a continuous time representation method to provide a unified odometry framework, which is suitable for LiDAR sensors with different scanning types and can also simultaneously fuse multiple asynchronous LiDAR sensors.

### BRIEF DESCRIPTION OF THE DRAWINGS

FIG. 1 is an overall flowchart of a LiDAR odometry using a piecewise linear continuous-time trajectory according to an embodiment of the present disclosure;

FIG. 2 is a frame diagram of the LiDAR odometry using a continuous-time trajectory according to an embodiment of the present disclosure; and

FIG. 3 shows a three-dimensional point cloud map reconstructed by using the LiDAR odometry according to an embodiment of the present disclosure.

### DETAILED DESCRIPTION OF THE EMBODIMENTS

The technical solutions in the present disclosure are clearly and completely described below with reference to the drawings of the present disclosure. All other embodiments obtained by those skilled in the art based on the embodiments of the present disclosure without creative efforts shall fall within the protection scope of the present disclosure.

To make the objectives, technical solutions and advantages of the present disclosure clearer, the embodiments of the present disclosure are described in detail below with reference to the drawings.

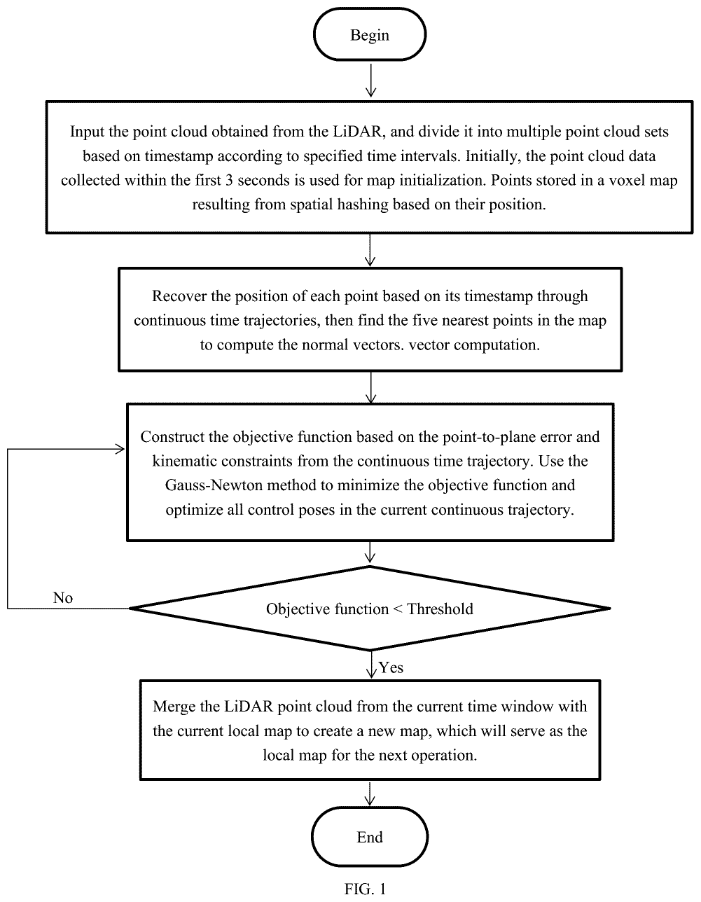

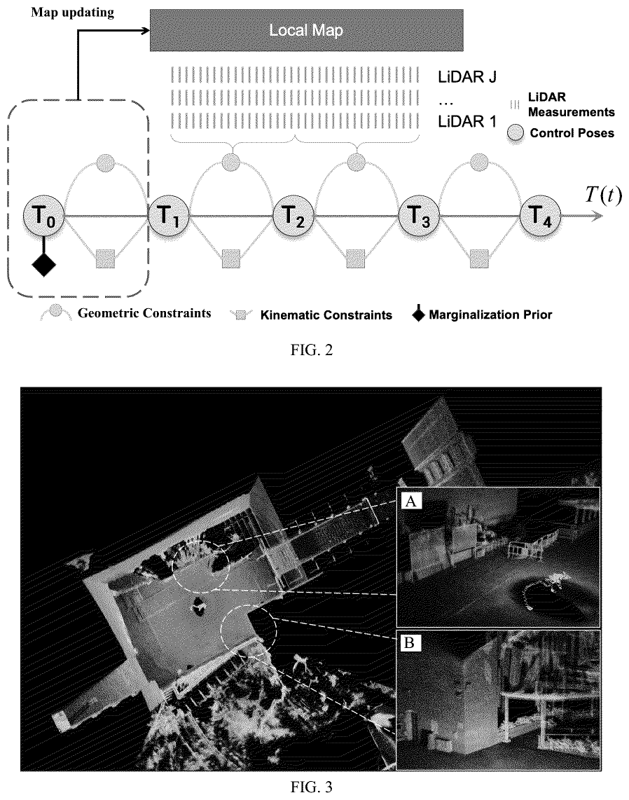

As shown in FIGS. 1 and 2, the present disclosure includes the following steps.
S1. An initial LiDAR point cloud time sequence acquired by a LiDAR sensor is divided through time windows to obtain LiDAR point cloud subsequences in the multiple time windows, and an initial local point cloud map is constructed.

Specifically, the initial LiDAR point cloud time sequence is denoted as T(t), where t is a time variable, focusing on trajectories within the time range of [t₀,t_{K}). Each time point corresponds to a pose of the LiDAR, and is denoted as Tt. All poses are represented in the world coordinate system, which is the starting position of the LiDAR. Specifically, the pose is the translation and rotation of a three-dimensional rigid body transformation. In order to handle rapid motion, the present disclosure divides the time window into K equally spaced small segments {[tₖ₋₁,tₖ)}ₖ₌₁^{K}, thereby dividing the initial LiDAR point cloud time sequence into K point cloud subsets. Each point cloud subset includes LiDAR point cloud data acquired during this time interval. In the initial stage, the initial local point cloud map is constructed directly based on the point cloud data acquired in the first 3 seconds. The map structure adopts a voxel hash table, and the information of each point is stored in a corresponding voxel based on the hash value of the three-dimensional coordinates.
S2. Based on starting pose Tₖ₋₁ and ending pose Tₖ, the LiDAR point cloud subsequence in each time window is linearly parameterized to obtain an initial continuous-time trajectory. In each segment [tₖ₋₁,kₖ), in terms of motion, the trajectory is linearly parameterized by the starting pose Tₖ₋₁ and the ending pose Tₖ. For each point, its position in the world coordinate system is linearly interpolated based on the timestamp information.
S3. Based on a current continuous-time trajectory and a current local point cloud map, a point-to-plane error corresponding to each point in the current time window k is calculated, thereby forming a point-to-plane error constraint, and a trajectory smoothness constraint is established.

In the step S3, the point-to-plane error corresponding to each point in the current time window k is specifically calculated as follows.

Firstly, it is supposed that there is point p; in the k-th time window [tₖ₋₁,tₖ), corresponding to the timestamp tᵢ of the acquisition time. Based on the current continuous-time trajectory, the position Tᵢ of the LiDAR in the world coordinate system at the corresponding time of the current point pᵢ is acquired. The position Tᵢ is acquired by linear interpolation based on the starting pose Tₖ₋₁ and the ending pose Tₖ corresponding to the current time window.

$$\begin{matrix}𝒯 = Log ( {T}_{k - 1}^{- 1} {T}_{k} ) , {T}_{i} = {T}_{k - 1} Exp ( {α}_{i} 𝒯 ) \\ α = ( {t}_{i} - {t}_{k - 1} ) / ( {t}_{k} - {t}_{k - 1} )\end{matrix}$$

where, Log and Exp denote logarithmic and exponential mappings of the three-dimensional rigid transformation, respectively; αᵢ denotes a time scaling coefficient; and τ denotes a tangent space vector corresponding to the pose transformation.

Then based on the position Tᵢ, multiple near points to the current point are found in the current local point cloud map, and the nearest point in the multiple near points is defined as qᵢ. Normal vector nᵢ corresponding to the multiple points is calculated by a principal component analysis (PCA) method. The point-to-plane error corresponding to each point is calculated as follows:

$${e}_{i} = {n}_{i}^{T} ( {T}_{i} {p}_{i} - {q}_{i} )$$

where, eᵢ denotes the point-to-plane error corresponding to the current point pᵢ, and T denotes a transpose.

This error is used to measure the geometric relationship between the LiDAR measurement data and the map, which is then used for motion estimation. The point-to-plane error constraint considers the continuity of the continuous-time trajectory, enabling the present disclosure to accurately estimate the motion of the LiDAR.

In the step S3, the trajectory smoothness constraint is expressed as follows:

$${e}_{{υ}_{k}} = {T}_{k} ⊖ {T}_{k - 1} - {{T}^{⋁}}_{k - 1} ⊖ {{T}^{⋁}}_{k - 2} .$$

where, eᵥ_{ₖ} denotes the trajectory smoothness constraint in a time window k; Tₖ⊖Tₖ₋₁ denotes a generalized velocity in the time window k; Ťₖ₋₁⊖Ťₖ₋₂ denotes a pseudo velocity measurement in the time window k, including the pose estimation values from the previous segment and used to measure trajectory changes within adjacent segments; Tₖ₋₁ and Tₖ denote a starting pose and an ending pose in the current window k, respectively, which are updated during the optimization process; and Ťₖ₋₂ and Ťₖ₋₁ denote a starting pose and an ending pose optimized in a previous time window k−1, respectively, which remain unchanged in the optimization in the current window k.
S4. An objective function is minimized based on the point-to-plane error constraint and the trajectory smoothness constraint by a Gauss-Newton method, and the continuous-time trajectory in the current time window k is estimated and updated.

The objective function is expressed as follows:

$$E = \sum {e}_{i}^{T} {e}_{i} + \sum {e}_{{v}_{k}}^{T} {e}_{{v}_{k}}$$

where, E denotes a total trajectory error; eᵢ denotes a point-to-plane error corresponding to the current point pᵢ in the current time window; eᵥ_{ₖ} denotes the trajectory smoothness constraint in the current time window k; and T denotes a transpose.

The objective function is minimized through an iterative Gauss-Newton method to acquire the final pose estimation result. The present disclosure lists the explicit Jacobian matrix required in the optimization process to improve optimization efficiency.

The Jacobian matrix corresponding to the plane error eᵢ is:

$$\begin{matrix}\frac{\partial {e}_{i}}{\partial [ {T}_{k - 1} {T}_{k} ]} = \frac{\partial {e}_{i}}{\partial {T}_{i}} [ \frac{\partial {T}_{i}}{\partial {T}_{k - 1}} \frac{\partial {T}_{i}}{\partial {T}_{k}} ] , \\ \frac{\partial {e}_{i}}{\partial {T}_{i}} = {n}_{i}^{T} [ {R}_{i} - {{R}_{i} [ {p}_{i} ]}_{\times } ] , \\ \frac{\partial {T}_{i}}{\partial {T}_{k - 1}} = ( 1 - {α}_{i} ) {J}_{r} ( ( {α}_{i} - 1 ) τ ) {J}_{l}^{- 1} ( τ ) , \\ \frac{\partial {T}_{i}}{\partial {T}_{k}} = {α}_{i} {J}_{r} ( {α}_{i} τ ) {J}_{r}^{- 1} ( τ ) .\end{matrix}$$

where, Jᵣ and Jₗ denote a right Jacobian matrix and a left Jacobian matrix in the three-dimensional space, respectively; and Rᵢ denotes a rotation matrix.

The Jacobian matrix of the smooth constraint eᵥ_{ₖ} is:

$$\frac{\partial {e}_{{υ}_{k}}}{\partial {T}_{k - 1}} = - {J}_{l}^{- 1} ( τ ) , \frac{\partial {e}_{{υ}_{k}}}{\partial {T}_{k}} = {J}_{r}^{- 1} ( τ ) .$$

S5. The steps S3 and S4 are repeated. A pose in the current time window is iteratively optimized based on the updated continuous-time trajectory until the objective function is less than a preset threshold, to obtain an optimal continuous-time trajectory in the current time window and a corresponding LiDAR point cloud in a world coordinate system. The LiDAR point cloud in the world coordinate system in the current time window is added to the current local point cloud map.
S6. The steps S2 to S5 are repeated. The LiDAR pose is sequentially optimized for the LiDAR point cloud subsequence in each time window to obtain an overall continuous-time trajectory, namely a pose within t_{K}. Based on the continuous trajectories calculated during this period and the LiDAR point cloud data acquired in the time window, a three-dimensional point cloud map around the LiDAR sensor is reconstructed. FIG. 3 shows a map reconstructed using this method in an outdoor scene, with details of (A-B).

The method proposed by the present disclosure can be widely used in fields such as robot navigation, simultaneous localization and mapping, and autonomous driving, and can provide accurate pose estimation information according to different sensor configurations and usage scenarios. Compared with existing LiDAR state estimation methods, the present disclosure has significant practical value and technical advantages. Firstly, the present disclosure adopts a continuous-time trajectory modeling approach. Compared to the discrete-time trajectory based LiDAR odometry, the present disclosure can directly fuse data from multiple asynchronous LiDAR sensors with different frequencies, effectively addressing the problem of single LiDAR sensor failing in degraded scenarios. Secondly, the present disclosure directly uses the point-to-plane error matching method without the need for additional feature filtering steps. Therefore, the present disclosure is applicable to LiDAR with different scanning modes, including multi-beam mechanical rotating LiDAR, rotating prism LiDAR, etc.

The present disclosure provides a high-precision motion estimation method for LiDAR, which is applicable to various types of LiDAR and various complex motion situations. The present disclosure significantly improves the robustness of the system under extreme conditions through the proposed piecewise linear continuous-time trajectory. In cases where certain motion states exceed the IMU range, the existing LiDAR odometry often fails, while the present disclosure can still stably track the state and output the corresponding pose information of the system. In addition, the present disclosure can maintain real-time computing on ordinary embedded edge computing devices through the derived Jacobian matrix in analytical form. The present disclosure has broad application prospects in the fields of robot navigation, simultaneous localization and mapping, and autonomous driving due to the above-mentioned innovative points. The application of the present disclosure will significantly improve the localization accuracy and navigation capability of robots and autonomous vehicles in complex environments, thereby promoting the development of these technological fields.

Finally, it should be noted that the above embodiments are only intended to explain, rather than to limit the technical solutions of the present disclosure. Those of ordinary skill in the art should understand that modifications or equivalent substitutions may be made to the technical solutions of the present disclosure without departing from the spirit and scope of the technical solutions of the present disclosure, but such modifications or equivalent substitutions should be encompassed within the scope of the claims of the present disclosure.

What is claimed is:

1. A LiDAR odometry using a piecewise linear continuous-time trajectory, comprising the following steps:
S1: dividing an initial LiDAR point cloud time sequence through time windows to obtain LiDAR point cloud subsequences in the time windows, and constructing an initial local point cloud map;
S2: linearly parameterizing the LiDAR point cloud subsequence in each time window to obtain an initial continuous-time trajectory;
S3: calculating, based on a current continuous-time trajectory and a current local point cloud map, a point-to-plane error corresponding to each point in a current time window, wherein a point-to-plane error constraint is formed; and establishing a trajectory smoothness constraint;
S4: minimizing, based on the point-to-plane error constraint and the trajectory smoothness constraint, an objective function by a Gauss-Newton method; and estimating and updating the continuous-time trajectory in the current time window to obtain an updated continuous-time trajectory;
S5: repeating the steps S3 and S4: iteratively optimizing a pose in the current time window based on the updated continuous-time trajectory until the objective function is less than a preset threshold, to obtain an optimal continuous-time trajectory in the current time window and a corresponding LiDAR point cloud in a world coordinate system; and adding the LiDAR point cloud in the world coordinate system in the current time window to the current local point cloud map; and
S6: repeating the steps S2 to S5: sequentially optimizing a LiDAR pose for the LiDAR point cloud subsequence in each time window to obtain an overall continuous-time trajectory.

2. The LiDAR odometry using a piecewise linear continuous-time trajectory according to claim 1, wherein in the step S3, the step of calculating the point-to-plane error corresponding to each point in the current time window comprises:
acquiring, based on the current continuous-time trajectory, a position Tᵢ of a LiDAR in the world coordinate system at a corresponding time of a current point pᵢ; finding multiple near points to the current point in the current local point cloud map, and defining a nearest point in the multiple near points as qᵢ; calculating, by a principal component analysis (PCA) method, a normal vector nᵢ corresponding to the multiple near points; and calculating the point-to-plane error corresponding to each point as follows:
$${e}_{i} = {n}_{i}^{T} ( {T}_{i} {p}_{i} - {q}_{i} )$$
wherein eᵢ denotes the point-to-plane error corresponding to the current point pᵢ, and T denotes a transpose.

3. The LiDAR odometry using a piecewise linear continuous-time trajectory according to claim 1, wherein in the step S3, the trajectory smoothness constraint is expressed as follows:
$${e}_{{υ}_{k}} = {T}_{k} ⊖ {T}_{k - 1} - {{T}^{⋁}}_{k - 1} ⊖ {{T}^{⋁}}_{k - 2} .$$
wherein eᵥ_{ₖ} denotes the trajectory smoothness constraint in a time window k; Tₖ⊖Tₖ₋₁ denotes a generalized velocity in the time window k; Ťₖ₋₁⊖Ťₖ₋₂ denotes a pseudo velocity measurement in the time window k; Tₖ₋₁ and Tₖ denote a starting pose and an ending pose in the current time window k, respectively; and Ťₖ₋₂ and Ťₖ₋₁ denote a starting pose and an ending pose optimized in a previous time window k−1, respectively.

4. The LiDAR odometry using a piecewise linear continuous-time trajectory according to claim 1, wherein the objective function is expressed as follows:
$$E = \sum {e}_{i}^{T} {e}_{i} + \sum {e}_{{v}_{k}}^{T} {e}_{{v}_{k}}$$
wherein E denotes a total trajectory error; eᵢ denotes a point-to-plane error corresponding to a current point pᵢ in the current time window; eᵥ_{ₖ} denotes the trajectory smoothness constraint in the current time window k; and T denotes a transpose.

5. A computer device, comprising a memory and a processor, wherein the memory is configured to store a computer program; and the computer program is executed by the processor to implement the steps of the LiDAR odometry according to claim 1.

6. A computer-readable storage medium, configured to store a computer program, wherein the computer program is executed by a processor to implement the steps of the LiDAR odometry according to claim 1.

7. The computer device according to claim 5, wherein in the step S3 of the LiDAR odometry, the step of calculating the point-to-plane error corresponding to each point in the current time window comprises:
acquiring, based on the current continuous-time trajectory, a position Tᵢ of a LiDAR in the world coordinate system at a corresponding time of a current point pᵢ; finding multiple near points to the current point in the current local point cloud map, and defining a nearest point in the multiple near points as qᵢ; calculating, by a principal component analysis (PCA) method, a normal vector nᵢ corresponding to the multiple near points; and calculating the point-to-plane error corresponding to each point as follows:
$${e}_{i} = {n}_{i}^{T} ( {T}_{i} {p}_{i} - {q}_{i} )$$
wherein eᵢ denotes the point-to-plane error corresponding to the current point pᵢ, and T denotes a transpose.

8. The computer device according to claim 5, wherein in the step S3 of the LiDAR odometry, the trajectory smoothness constraint is expressed as follows:
$${e}_{{υ}_{k}} = {T}_{k} ⊖ {T}_{k - 1} - {{T}^{⋁}}_{k - 1} ⊖ {{T}^{⋁}}_{k - 2} .$$
wherein eᵥ_{ₖ} denotes the trajectory smoothness constraint in a time window k; Tₖ⊖Tₖ₋₁ denotes a generalized velocity in the time window k; Ťₖ₋₁⊖Ťₖ₋₂ denotes a pseudo velocity measurement in the time window k; Tₖ₋₁ and Tₖ denote a starting pose and an ending pose in the current time window k, respectively; and Ťₖ₋₂ and Ťₖ₋₁ denote a starting pose and an ending pose optimized in a previous time window k−1, respectively.

9. The computer device according to claim 5, wherein in the LiDAR odometry, the objective function is expressed as follows:
$$E = \sum {e}_{i}^{T} {e}_{i} + \sum {e}_{{v}_{k}}^{T} {e}_{{v}_{k}}$$
wherein E denotes a total trajectory error; eᵢ denotes a point-to-plane error corresponding to a current point pᵢ in the current time window; eᵥ_{ₖ} denotes the trajectory smoothness constraint in the current time window k; and T denotes a transpose.

10. The computer-readable storage medium according to claim 6, wherein in the step S3 of the LiDAR odometry, the step of calculating the point-to-plane error corresponding to each point in the current time window comprises:
acquiring, based on the current continuous-time trajectory, a position Tᵢ of a LiDAR in the world coordinate system at a corresponding time of a current point pᵢ; finding multiple near points to the current point in the current local point cloud map, and defining a nearest point in the multiple near points as qᵢ; calculating, by a principal component analysis (PCA) method, a normal vector nᵢ corresponding to the multiple near points; and calculating the point-to-plane error corresponding to each point as follows:
$${e}_{i} = {n}_{i}^{T} ( {T}_{i} {p}_{i} - {q}_{i} )$$
wherein eᵢ denotes the point-to-plane error corresponding to the current point pᵢ, and T denotes a transpose.

11. The computer-readable storage medium according to claim 6, wherein in the step S3 of the LiDAR odometry, the trajectory smoothness constraint is expressed as follows:
$${e}_{{υ}_{k}} = {T}_{k} ⊖ {T}_{k - 1} - {{T}^{⋁}}_{k - 1} ⊖ {{T}^{⋁}}_{k - 2} .$$
wherein eᵥ_{ₖ} denotes the trajectory smoothness constraint in a time window k; Tₖ⊖Tₖ₋₁ denotes a generalized velocity in the time window k; Ťₖ₋₁⊖Ťₖ₋₂ denotes a pseudo velocity measurement in the time window k; Tₖ₋₁ and Tₖ denote a starting pose and an ending pose in the current time window k, respectively; and Ťₖ₋₂ and Ťₖ₋₁ denote a starting pose and an ending pose optimized in a previous time window k−1, respectively.

12. The computer-readable storage medium according to claim 6, wherein in the LiDAR odometry, the objective function is expressed as follows:
$$E = \sum {e}_{i}^{T} {e}_{i} + \sum {e}_{{v}_{k}}^{T} {e}_{{v}_{k}}$$
wherein E denotes a total trajectory error; eᵢ denotes a point-to-plane error corresponding to a current point pᵢ in the current time window; eᵥ_{ₖ} denotes the trajectory smoothness constraint in the current time window k; and T denotes a transpose.
